(19) United States
(12) Patent Application Publication
(10) Pub. No.: US 2009/0254358 A1
(43) Pub. Date: Oct. 8, 2009

(54) METHOD AND SYSTEM FOR FACILITATING REAL WORLD SOCIAL NETWORKING THROUGH VIRTUAL WORLD APPLICATIONS

(76) Inventors: FuYi Li, Sudbury, MA (US); Pamela Ann Nesbitt, Tampa, FL (US); Angela Richards Jones, Durham, NC (US); Ruthie D. Lyle, Durham, NC (US); Vandana Mallempati, Austin, TX (US)

Correspondence Address: LOTUS AND RATIONAL SOFTWARE;David A. Dagg, Esq., 44 Chapin Road, Newton, MA, 02459, US

(21) Appl. No.: 12/099,095

(22) Filed: Apr. 7, 2008

(51) Int. Cl. G06Q 99/00; G06F 7/06; G06F 17/30; G06F 3/048

(52) U.S. Cl. 705/1; 707/3; 715/757; 707/E17.048; 707/E17.014

(57) ABSTRACT

A method and system for enhancing a virtual world application to facilitate social networking between users are disclosed. The system detects a trigger condition within the virtual world application, and in response to detecting the trigger condition, searches one or more real world social networking application relationship databases for real world social network relationships between a first user of the virtual world application and at least one other user of the virtual world application. Based on the results of the searching performed on the social networking application relationship databases, the disclosed system displays alerts containing real world social network information describing real world social networks connecting the first user and one or more other users of the virtual world application that were detected by the searching.

### FIELD OF THE INVENTION

The invention relates generally to virtual world computer system applications, and more specifically to a method and system for facilitating social networking through virtual world applications.

### BACKGROUND OF THE INVENTION

As it is generally known in the area of computer science, a “virtual world” is a computer-based simulated environment that its users inhabit and interact with via corresponding avatars. Each avatar is an on-line representation of a corresponding user within the virtual world, such as a textual, two-dimensional, and/or three-dimensional graphical representation of the corresponding user. Avatars in typical existing virtual world applications maintain the anonymity of their corresponding users with regard to other users of the virtual world application.

When a virtual world application is executed, the user can access constructs of the computer-simulated world by manipulating (e.g. moving) their avatar through/within the virtual world. For example, virtual constructs provided within a virtual world may include various specific types of virtual locations (e.g. virtual islands, virtual cities, virtual buildings, virtual rooms, etc.), virtual events (e.g. virtual conferences, virtual meetings, etc.), and others.

Examples of existing virtual world applications include what are sometimes referred to as freeform Metaverse applications, such as the Second Life® application developed by Linden Research, Inc. Second Life includes a downloadable client program (the Second Life Viewer), that enables its users, referred to as “Residents”, to interact with each other through motional avatars. Residents of Second Life can explore the Second Life virtual world, meet and/or socialize with the avatars of other Residents, socialize, and create and trade items (virtual property) and services from one another. However, a problem exists with virtual world applications such as Second Life, in that there is no way for its users to discover and exploit business and/or other types of external, real-world social network relationships that exist between the users corresponding to the Second Life avatars. Accordingly, Second Life users cannot conveniently recognize or find other users that share the same interests as they do, and/or work in the same company. Moreover, Second Life users cannot determine whether any such other users are currently available for social networking external to the Second Life metaverse. This prevents virtual world users from taking advantage of many existing social networking applications external to the virtual world application, while performing virtual world activities. User relationships defined through social networking applications external to the virtual world support networking activity beyond that possible through virtual world by itself, and may include significant user relationships, e.g. such as may be defined through on-line communities, company LDAP (Lightweight Directory Access Protocol) directories, etc. While it may often be desirable keep a virtual world user's real-world (aka “first life”) identity and/or social network relationship information private, it would also be desirable to have a system that allows users to selectively allow access to such information, and/or allows users to selectively or automatically access real world social network relationships based in response to avatar actions performed in the virtual world.

The above described capabilities are lacking in existing virtual world systems, and are also not present in existing external systems, such as the SLProfiles.com service. The service provided by SLProfiles.com enables users to meet other users of Second Life within a real world on-line community. However, SLProfiles does create a sufficient connection between a user's social networking relationships in the real world and the actions of users' avatars in the virtual world. Accordingly, such existing external systems also do not allow virtual world users to effectively and dynamically distribute and/or obtain external real world social network information in real time responsive to actions performed by avatars in the virtual world.

### SUMMARY OF THE INVENTION

To address the above described and other shortcomings of previous approaches, a method and system for enhancing a virtual world application to facilitate social networking between users is disclosed. The disclosed system detects a trigger condition within the virtual world application, and in response to detecting the trigger condition, searches one or more real world social networking application relationship databases for social network relationships between a first user of the virtual world application and at least one other user of the virtual world application. Based on the results of the searching performed on the social networking application relationship databases, the disclosed system displays alerts containing real world social networking application relationship information describing real world social networks connecting the first user and one or more other users of the virtual world application that were detected by the searching.

The trigger condition of the disclosed system may be an implicit trigger condition, such that detection of the trigger condition includes automatically detecting when an avatar corresponding to the second user has entered a current context within the virtual world application that also contains an avatar of the first user. Such a current context of the virtual world application may include a current virtual location (e.g. virtual island, virtual city, virtual building, virtual room, etc.) in which the avatar for the first user is currently located, a current virtual event (e.g. virtual meeting, virtual conference, etc.) that the avatar for the first user is currently attending, and/or any other specific current context in the virtual world that are shared by both the avatar for the first user of the virtual world application and the avatar for the second user of the virtual world application.

The trigger condition may alternatively be an explicit trigger condition, such that detection of the trigger condition includes detecting that the first user has requested a search for real world social network relationship information for one or more users corresponding to selected avatars in the virtual world, e.g. that share a current virtual context with the avatar of the first user. Such a user request may, for example, consist of the first user clicking on or otherwise indicating or selecting one or more of the avatars in the current context of the virtual world containing the first user's avatar.

The information displayed regarding detected real world social network relationships between the first user and one or more other users associated with avatars located in the same current context as the first user's avatar may include any specific type of information describing the relationships. For example, the displayed information may include a real world identifier of the second user, such as an electronic mail address, instant messaging screen name, etc., and/or a name or description of the real world social networking application through which the first user and the second user are related, and/or a group name or the like through which the first user and the second user are related by or within the real world social networking application.

The disclosed system enables users to control the specific real world social networking application relationship information that can be shared with other users, and how any such information can shared through the virtual world application. In this regard the disclosed system generates one or more configuration user interface displays through which a user can input or otherwise select control settings indicating how real world social networking application information is to be shared with other users of the virtual world application. For example, embodiments of the disclosed system may provide control settings that control how a user is to be notified of real world social network relationships between the user and other users of the virtual world application, e.g. through pop-up windows, hover-over context displays generated in response to the user hovering the cursor over avatars of other users in the virtual world application, etc. Controls setting may further be provided that limit and/or identify the specific avatar(s) through which a user's real world social networking application relationship information is permitted to be exposed through the virtual world application, the specific time, virtual location, and/or virtual events within which the user's real world social networking application relationship information is permitted to be exposed through the virtual world application, and/or the specific other users (e.g. which real world user groups, etc.) to which the user's real world social networking application relationship information is permitted to be exposed through the virtual world application.

Thus there is disclosed a method and system that allows virtual world users to access and/or control access to real world social network relationships with other users based on avatar actions performed in the virtual world.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a block diagram showing components in an illustrative embodiment of the disclosed system;

FIG. 2 is a flow chart showing steps performed during operation of an illustrative embodiment of the disclosed system;

FIG. 3 is a second flow chart showing steps performed during operation of an illustrative embodiment of the disclosed system; and

FIG. 4 is a flow chart showing steps performed during a use case example of operation of an illustrative embodiment of the disclosed system.

### DETAILED DESCRIPTION OF EXEMPLARY EMBODIMENTS

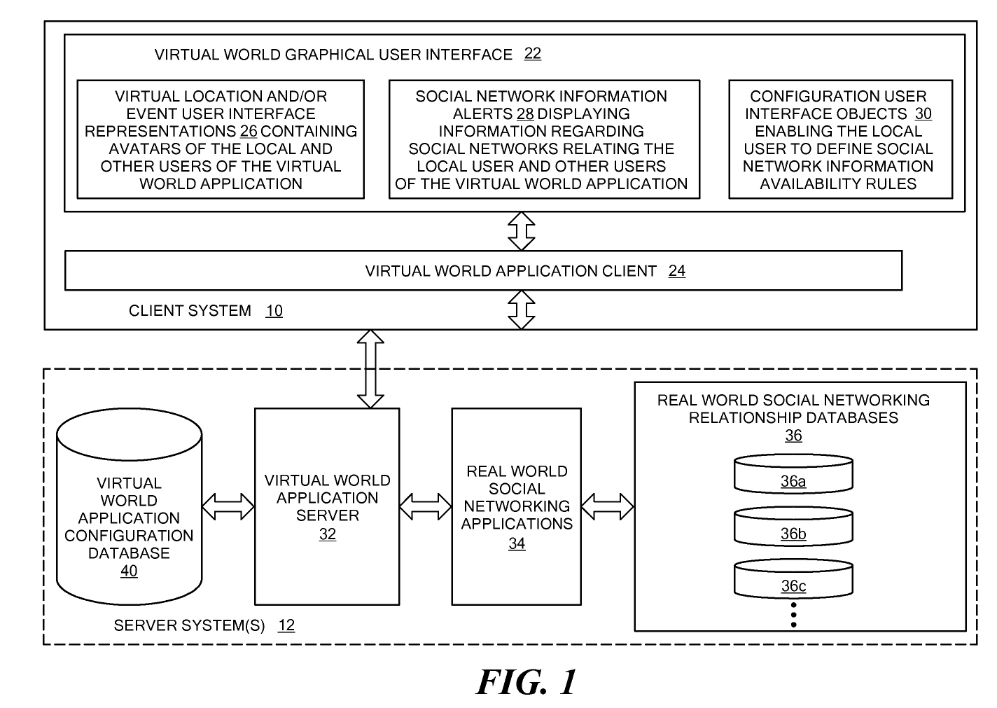

As shown in FIG. 1, an illustrative embodiment of the disclosed system includes components in a number of clients systems, shown for purposes of illustration by Client System 10, and one or more Server Systems 12. The Client System 10 includes a Virtual World Application Client 24 that generates a Virtual World Graphical User Interface 22 for a local user of the Client System 10. The Virtual World Graphical User Interface 22 includes User Interface Representations 26 of one or more virtual locations and/or virtual events in which may be located an avatar representing the local user and/or one or more avatars representing one or more corresponding other users (aka other “residents”) of the virtual world provided by a virtual world application. For purposes of illustration, an example of a virtual world application is shown in FIG. 1 by the Virtual World Application 24 and Virtual World Application Server 32.

The virtual locations and/or virtual events in the User Interface Representations 26 are part of a virtual world provided to the local user and other users by the virtual world application. The virtual world may be or include any specific type of virtual reality, and allows users to interact with a computer-simulated environment through their corresponding avatars. For example, the virtual world may provide visual models of virtual locations and/or events, displayed on a display device of each user's computer system, and may additionally or alternatively generate additional sensory information, such as sound output to users through speakers or headphones. Users of the virtual world application can interact with the virtual world either through the use of standard input devices such as a keyboard and mouse, and/or through specialized multimodal devices such as a 3-D joystick, a wired or wireless controller (e.g. a handheld pointing device that can detect acceleration in three dimensions, wired gloves such as simulated boxing gloves, etc.).

Examples of virtual world locations that may be represented in the User Interface Representations 26 include virtual islands, virtual countries, virtual cities, virtual buildings, virtual rooms, etc. Examples of virtual world events that may be represented by the User Interface Representations 26 include virtual meetings, virtual conferences, virtual presentations, etc.

Avatars representing corresponding users in the Virtual World Graphical User Interface 22 may be any specific type of visual and/or other perceptible representation. For example, the avatars may include three-dimensional models, as are often used in computer games, two-dimensional icons (e.g. pictures, pixelized representations of a person or creature, etc.), as are often used in Internet forums and other on-line communities, animated avatars (e.g. consisting of a sequence of multiple images played repeatedly), etc.

The Virtual World Graphical User Interface 22 further includes Social Network Information Alerts 28 displaying information regarding real-world social networks that relate the local user of the Client System 10 to other users of the virtual world. The Social Network Information Alerts 28 may be embodied using any specific kind of notification display object displayed in or output in connection with the Virtual World Graphical User Interface 22. For example, the Social Network Information Alerts 28 may include textual information super-imposed over or displayed in close visual proximity to relevant avatars in the Virtual World Graphical User Interface 22, pop-up windows generated over or outside of the Virtual World Graphical User Interface 22, sound messages (e.g. digitized speech) output through a speaker in the Client System 10, mouseover events produced when a user moves or “hovers” the cursor over a particular area (e.g. an avatar) within the Virtual World Graphical User Interface 22 (e.g. a “tooltip” display object). The Social Network Information Alerts 28 may provide various specific information regarding social network relationships, such as a short description of a social network relationship between the local user and another user corresponding to an avatar currently located under the cursor, and/or a real-world identifier (e.g. electronic mail address) of the other user corresponding to the avatar currently located under the cursor), etc.

Further provided in the Virtual World Graphical User Interface 22 are one or more Configuration User Interface Objects 30 that enable the local user to define network availability rules. The Configuration User Interface Objects 30 may be embodied using any specific type of user interface objects, using on-line forms, menus, dialog boxes, etc. The Configuration User Interface Objects 30 enable a local user to define specific avatars associated with the user through which real-world social network information about the local user can be exposed to other users, specific virtual locations in which real-world social network information about the local user can be exposed to other users, specific virtual events during which real-world social network information about the local user can be exposed to other users, specific times during which real-world social network information about the local user can be exposed to other users, and/or other configuration information that controls how social network information about the local user can be exposed to other users in response to actions detected within the virtual world. The configuration information provided through the Configuration User Interface Objects 30 may also define how real world social network information about other users is to be exposed to the local user, e.g. whether checking for social network relationships with other users corresponding to avatars in the virtual world is explicitly or implicitly triggered, the type of and/or format in which social network relationship information is displayed within the Virtual World Graphical User Interface 22, etc. Configuration information received through the Configuration User Interface Objects 30 is stored in a Virtual World Application Configuration Database 40 on Server Systems 12.

The Server Systems 12 of FIG. 1 are shown including Virtual World Server 32, Real World Social Networking Applications 34, Real World Social Networking Relationship Databases 36 (e.g. 36a, 36b, 36c . . . ), and the aforementioned Virtual World Application Configuration Database 40. The Virtual World Server 32 operates with the Virtual World Application Client 24 to generate the virtual world displayed to the user through the Virtual World Graphical User Interface 22. The Virtual World Server 32 further includes logic for determining when to generate, and for generating, the Social Network Information Alerts 28 through the Virtual World Application Client 24. When determining when to generate, and when generating the Social Network Information Alerts 28, the Virtual World Server 32 may use information retrieved from the Virtual World Application Configuration Database 40, and inter-operates with the Real World Social Networking Applications 34 to access information stored in the Real World Social Networking Relationship Databases 36.

The Real World Social Networking Relationship Databases 36 may include any specific type of real world social network relationships between users. For example, real world social network information that may be represented in the Real World Social Networking Relationship Databases 36 includes names and summary definitions of real-world on-line communities (e.g. user groups), and the real-world identifiers (e.g. electronic mail addresses, instant messaging screen names, etc.) of members in such on-line communities. The Real World Social Networking Applications 34 may include applications through which social networks made up of on-line user groups (sometimes referred to as “communities”) are defined and stored in the Real World Social Networking Relationship Databases 36. Such applications allow definition of restricted on-line user communities, to which membership is restricted to those users that are invited to join by an existing member and/or by an administrator or founding user. Other on-line communities described in the Real World Social Networking Relationship Databases 36 may be public, allowing anyone to become a member, e.g. simply through a sign up procedure during which the prospective member provides a user identifier and/or contact information, such as an electronic mail address and/or instant messaging screen name. Real World Social Networking Applications 34 may use any conventional type of authentication to authenticate users and/or maintain privacy within a given community, such as user name/password or other techniques.

The on-line communities provided by the Real World Networking Applications 34 and stored in the Real World Networking Relationship Databases 36 allow members to share information with other community members, and/or with non-members. For example, in a private on-line community, a private community resource such as an online forum or bulletin board, notes conference, or the like, is only accessible (e.g. viewable and/or modifiable) by community members. Alternatively, some on-line communities may allow non-members to view the contents of their bulletin board postings. Other types of information sharing may also or alternatively be used within the on-line communities. For example, some of the Real World Social Networking Applications 34 may allow members of their associated on-line communities to conveniently send messages (e.g. electronic mail messages, instant messages, etc.) to all other members of the community through a group message composition interface, and/or by specifying a unique group name in the “To:” field of a message composition user interface. On-line communities are examples of real world social networks that allow users to actively share information regarding common interests, professions, etc.

Other types of real-world social networks that may be supported by the Real World Social Networking Applications 34 include user directories in which multiple users may be related by values of their user attributes. For example, attribute values for the user entries in a hierarchical employee directory (e.g. based on LDAP or the like) may describe the organizational structure (e.g. reporting hierarchy) of a business organization, the real world location of each employee, the business unit, division, or project for each employee, etc. Based on such a directory, real world social networks can be maintained and/or obtained that are made up of all employees above a given position or person in the reporting hierarchy, all employees below a given position or person in the reporting hierarchy, all employees at a given level of the reporting hierarchy, all employees associated with a given physical location or facility, all employees within a specific business unit, division or project, etc.

Other examples of social networks provided through the Real World Social Networking Applications 34 and stored in the Real World Social Networking Relationship Databases 36 may include networks of users defined through social networking Web sites (e.g. MySpace, LinkedIn, etc.). Such Web sites allow definition of user-submitted real world social networks of friends, as well as posting and sharing of personal profiles, blogs, photos, music and videos.

The Client System 10 of FIG. 1 may be any specific type of computer system and/or intelligent electronic device, such as a desktop, laptop, or palmtop computer system, and/or personal digital assistant, cell phone, or other electronic device. The Client System 10 includes or controls display devices capable of displaying a graphical user interface (e.g. including Virtual World Graphical User Interface 22) to a respective local user, such as a liquid crystal display (LCD), cathode ray tube (CRT), interferometric modulator display (IMOD), light emitting diode (LED), or the like.

Those skilled in the art will further recognize that the Virtual World Application Client 24, Virtual World Application Server 32, and Real World Social Networking Applications 34 of FIG. 1 may be embodied using software or firmware, such as computer application program code, operating system program code, or middleware, and/or wholly or partly using digital hardware components, such as application specific integrated circuits (ASICs), field-programmable gate arrays (FPGAs), and the like, and/or combinations of hardware and/or software or firmware. The Virtual World Application Configuration Database 40 and Real World Social Networking Relationship Databases 36 may be embodied using any specific type of database technologies.

Those skilled in the art will further recognize that the Client System 10 and Server System(s) 12 of FIG. 1 may each include one or more processors, and program storage, such as memory, for storing program code executable on such processors, as well as input/output devices and/or interfaces. In the example of FIG. 1, the Client Systems 10 and Server System(s) 12 are interconnected by a data communication network (e.g. the Internet, a Local Area Network, etc.) through one or more of such input/output devices or interfaces, and through which may further be provided communication to a number of other client systems and/or remote server systems.

While for purposes of concise illustration a limited number of client systems are shown in FIG. 1, the disclosed system is not limited to any specific number of client systems. Moreover, while certain functions are described as being performed in the Client System 10 and in the Server System(s) 12, the disclosed system is not limited to any specific configuration or implementation in that regard. Accordingly, operations described as occurring in the Client System 10 may alternatively be performed in the Server System(s) 12, and vice versa. In addition, while the illustrative embodiment of FIG. 1 is implemented in a client-server architecture, the disclosed system is not limited to such an embodiment, and may alternatively be embodied using any other specific type of system architecture that may be appropriate and/or advantageous for a given implementation.

Similarly, while specific examples of real world social networks and virtual worlds are given above for purposes of explanation, the disclosed system is not limited to operation with any specific type of real world social network or virtual world. Accordingly, various other embodiments may involve or use any other specific types of virtual worlds and/or real world social networks.

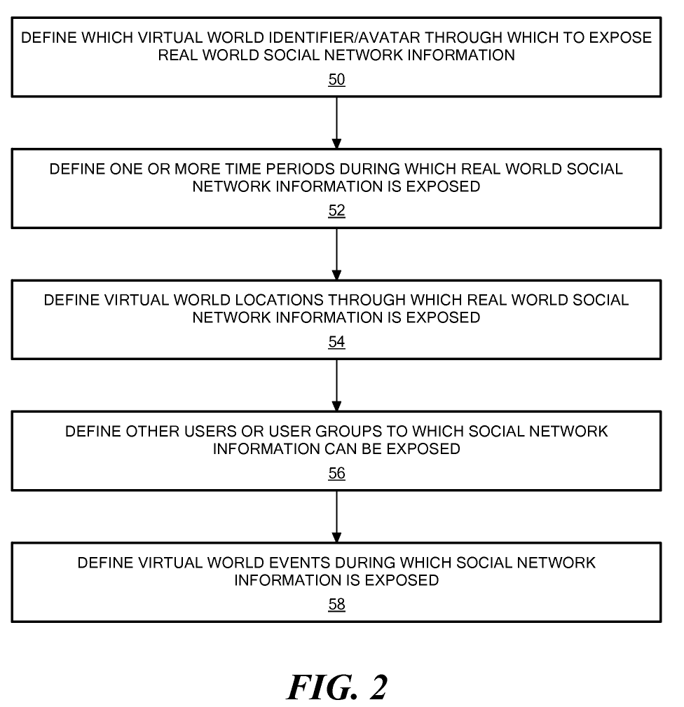

FIG. 2 is a flow chart showing steps performed during operation of an illustrative embodiment of the disclosed system. For example, the steps of FIG. 2 may be performed using the Configuration User Interface Objects 30 shown in FIG. 1, and the configuration information received by the disclosed system during the steps of FIG. 2 may be stored wholly or partially within the Virtual World Application Configuration Database 40, and/or within the Real World Social Networking Relationship Databases 36.

At step 50, the disclosed system generates one or more user interface display objects that enable a user to define or select one or more virtual world identifiers or avatars through which to expose real world social network information in a virtual world application. For example, a user may use multiple avatars to interact with a virtual world provided by a virtual world application, but desire to allow real world social network information about the user (e.g. including a real world identifier of the user such as an electronic mail address, instant messaging screen name, names of real world social networks to which the user belongs, etc.) to be exposed only through a subset of those avatars. Accordingly, at step 50 the disclosed system allows the user to select which one or more of his or her avatars for a virtual world are enabled with regard to providing real world social network information about the user to other virtual world application users based on actions of avatars within the virtual world.

At step 52, the disclosed system generates one or more user interface objects that enable a user to define one or more time periods during which real world social network information regarding the user can be exposed to other users in the virtual world application. For example, the disclosed system may enable a user to indicate certain days of the week (e.g. weekdays, weekends, etc.) during which real world social network information is exposed, such that real world social network information regarding the user is not exposed through the virtual world application during the remaining days of the week. Similarly, at step 52 the disclosed system may enable the user to define certain times of day during which real world social network information regarding the user can be exposed to other virtual user application users. The days or times defined at step 52 may either be repeating (e.g. the same for every month, every week, every day, etc,), or non-repeating.

At step 54, the disclosed system generates one or more user interface display objects that enable the user to define virtual locations through which real world social network information regarding the user can exposed to other users of the virtual world application. For example, the disclosed system may enable the user to define one or more virtual locations in the virtual world such that when the user's avatar is located within those virtual locations, other users can access information regarding the real world social networks of the user, and otherwise, if the user's avatar is not located within those defined virtual locations, other users cannot access such real world social network information about the user.

At step 56, the disclosed system generates one or more user interface display objects that enable the user to define one or more other users or user groups to which the user's real world social network information may be provided. For example, at step 56, the disclosed system may enable the user to indicate an individual user, domain, group name, etc., indicating one or more other users that can be provided information about the user's real world social networks. Alternatively, the disclosed system may enable a user to indicate at step 56 one or more other users or user groups to which social network information about the user is to be blocked.

At step 58, the disclosed system generates one or more user interface display objects that enable the user to define one or more virtual world events during which social network information about the user can be exposed to other users of the virtual world application. For example, at step 58, the disclosed system may enable the user to indicate an event (e.g. a virtual world conference) during which real world social network information about the user can be exposed to other users of the virtual world application.

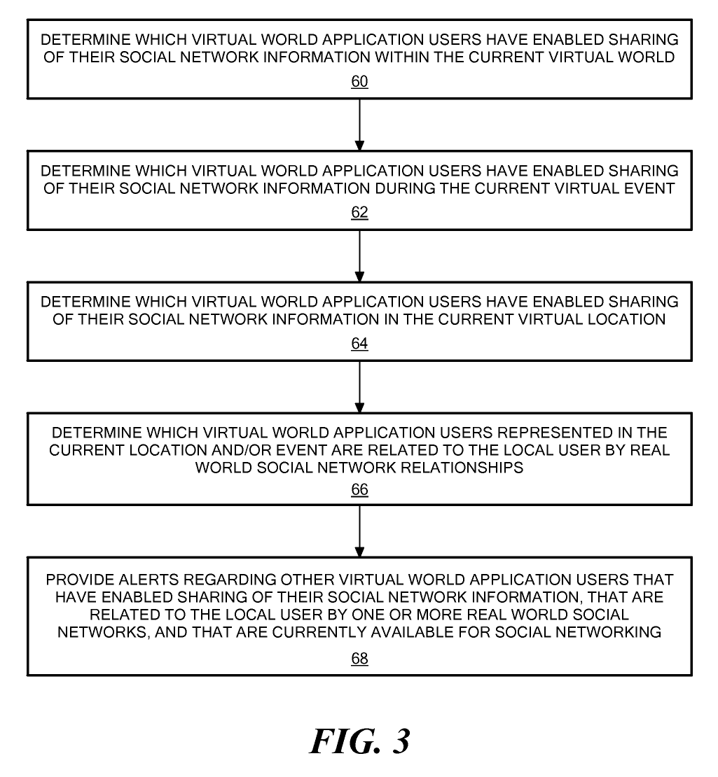

FIG. 3 is a second flow chart showing steps performed during operation of an illustrative embodiment of the disclosed system. At step 60, the disclosed system determines which other virtual world application users are available for social networking in the current virtual world. At step 62, the disclosed system determines which other virtual world application users have enabled sharing of their social network information in a current virtual event within the current virtual world. For example, the disclosed system may operate at step 62 to determine which virtual world application users having avatars attending a current virtual conference in the virtual world (e.g. a virtual conference that the local user's avatar is currently attending) have enabled sharing of their real world social network information while their avatars are attending the virtual conference.

At step 64, the disclosed system determines which virtual world application users have enabled sharing of their real world social network information in the current virtual location. For example, the disclosed system may operate at step 64 to determine which virtual world application users having avatars currently within a current virtual island (e.g. a virtual island on which the local user's avatar is currently located) have enabled sharing of their real world social network information while their avatars are located on the virtual island.

At step 66 the disclosed system determines which other users of the virtual world application that are currently represented in (e.g. have their associated avatars in) the current virtual location and/or event (e.g. the current location and/or event containing the local user's avatar) are related to the local user by one or more real world social networks. Then, at step 68, the disclosed system operates to provide alerts to the local user regarding other virtual world application users 1) that have enabled sharing of real world social network information in the current virtual world, virtual location, and/or virtual event, 2) that are related to the local user through one or more real world social networks, and 3) that are currently available for social networking (e.g. have indicated that their social network information can be shared at the current time, and/or are currently logged into their instant messaging application or the like and have a current on-line status indicating that they are currently available to receive messages.

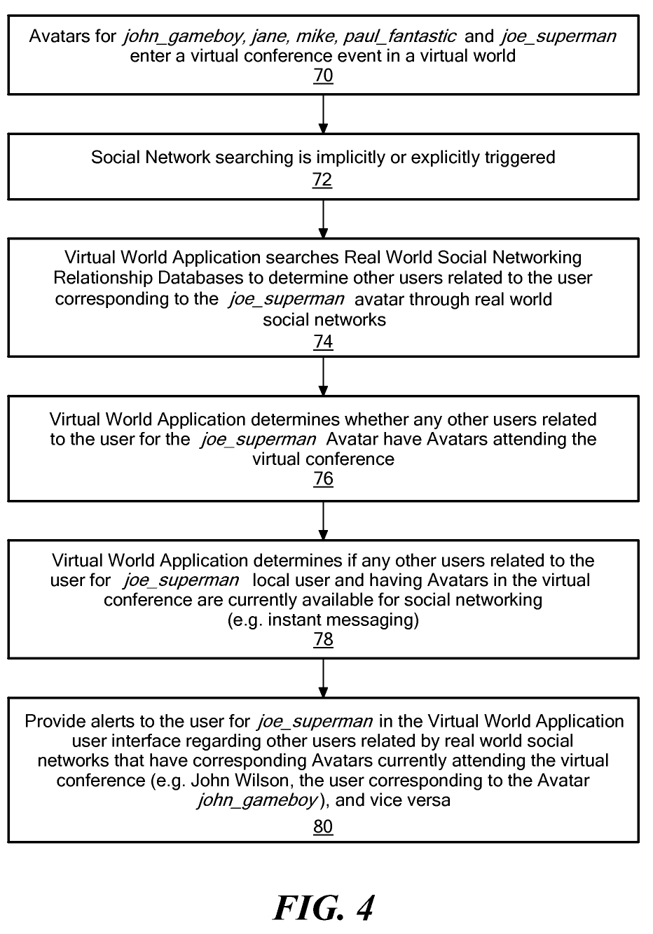

FIG. 4 is a flow chart showing steps performed during a use case example of operation of an illustrative embodiment of the disclosed system. At step 70, avatars for virtual world users having virtual world identifiers of john_gameboy, jane, mike, paul_fantastic and joe_superman enter a virtual conference in a virtual world provided by a virtual world application. The avatars for the virtual world users with identifiers john_gameboy, jane, mike, paul_fantastic and joe_superman may take any specific form, for example including two dimensional graphical objects or the like. Similarly, the virtual conference may be visualized in any particular form in the virtual world user interface, e.g. as a virtual conference room containing the avatars attending the virtual conference. In the example of FIG. 4, the name of the virtual conference is “Web 2.0”. Further in the example of FIG. 4, the virtual world user having a virtual user identifier of joe_superman represents a local user named “Joe Smith”.

At step 72, checking of real world social networks is triggered either explicitly by the local user, or implicitly. In the case where checking of real world social networks is triggered explicitly, the local user “Joe Smith” having virtual world identifier joe_superman sees four avatars other than his own avatar currently in the virtual conference, and performs an action using a user interface device (e.g. a mouse) that explicitly triggers searching for real world social network relationships between “Joe Smith” and the users represented by the four other avatars. Such an action may, for example, include clicking on or otherwise selecting the four other avatars, or some other explicit action in the user interface. Alternatively, in the case where checking of real world social network relationships is triggered implicitly, an event handler program operates to detect when each avatar enters the virtual conference, and automatically checks to see if each user corresponding to an avatar that enters the virtual conference is related to “Joe Smith” by one or more real world social networks.

Next, at step 74, the disclosed system searches the real world social networks (e.g. as contained in the Real World Social Networking Relationship Databases 36 of FIG. 1) of “Joe Smith” to determine whether any of the users contained in the virtual conference are related to “Joe Smith” by one or more real world social networks. For example, “Joe Smith” may belong to a number of on-line “communities”, including a “Porsche Owners Community”, a “Music Fun Community”, a “Collaboration Community” and a “Customer Support Community”. When checking these on-line communities, the disclosed system determines that the “Porsche Owners Community” includes the following member entries:

Joe_Smith@hal.us.com (Virtual World ID=joe_superman)

John_Wilson@hal.us.com (Virtual World ID=john_gameboy)

Jane_Li@hal.us.com (Virtual World ID=N/A)

Dave_Jones@hal.us.com (Virtual World ID=blah blah)

Similarly, when checking the on-line communities of “Joe Smith”, the disclosed system determines that the “Music Fun Community” includes the following member entries:

Joe_Smith@hal.us.com (Virtual World ID=joe_superman)

Jane_Li@hal.us.com (Virtual World ID=N/A)

Dave_Jones@hal.us.com (Virtual World ID=blah blah)

Paul_Smith@hal.us.com (Virtual World ID=paul_fantastic)

Based on the above results of searching the real world social networks of “Joe Smith”, the disclosed system determines that virtual world users (e.g. account holders with the virtual world application) having the virtual world identifiers paul_fantastic, blah blah, and john_gameboy are related to “Joe Smith” through real world social networks.

At step 76, the disclosed system determines whether any of the virtual world users that are related to “Joe Smith” through real world social networks are currently attending the virtual conference in which the avatar for “Joe Smith” is currently located. For example, during step 76, the disclosed system checks the user entries for virtual world application users (e.g. as stored in the Virtual World Application Configuration Data 40 of FIG. 1), and finds the following user entries:

Joe_Smith@hal.us.com (Virtual World ID=joe_superman) (Current Virtual Location: attending “Web 2.0” virtual conference) (Current Social Networking Status: available)

John_Wilson@hal.us.com (Virtual World ID=john_gameboy) (Current Virtual Location: attending “Web 2.0” virtual conference) (Current Social Networking Status: available)

Dave_Jones@hal.us.com (Virtual World ID=blah blah) (Current Virtual Location: attending “Web 2.0” virtual conference) (Current Social Networking Status: not available)

Paul_Smith@hal.us.com (Virtual World ID=paul_fantastic) (Current Virtual Location: attending “Web 2.0” virtual conference) (Current Social Networking Status: busy)

Using the information from the above user entries, the disclosed system can accordingly determine that the virtual world users with virtual world identifiers john_gameboy, blah blah and paul_fantastic have avatars that are currently attending the virtual conference that is also being attended by the avatar for the local user “Joe Smith”. However, at step 76, the disclosed system also determines from the above user entries that only the virtual world user with virtual user identifier john_gameboy both has an avatar attending the virtual conference, and has a current status indicating that the corresponding user is currently available for real world social network application activities (e.g. instant messaging, etc.) with the local user “Joe Smith”. Accordingly, at step 80, the disclosed system operates to generate an alert message (e.g. one of Alerts 28 shown in FIG. 1) within the virtual world application user interface for the local user “Joe Smith” (virtual world identifier joe_superman), indicating that the avatar for the user having virtual user identifier john_gameboy represents the real world user named “John Wilson”, that “John Wilson” is related to “Joe Smith” through the real world social network named “Porsche Owners Community”, and that “John Wilson” is currently available for real world social networking (e.g. instant messaging). Other information may also be provided through the alert generated to “Joe Smith”, such as the real world location of “John Wilson”, and/or other information.

Similarly, an alert message is generated in the virtual world application user interface of the user “John Wilson” (virtual world identifier john_gameboy), indicating that the avatar for the user having virtual user identifier joe_superman represents the real world user named “Joe Smith”, that “Joe Smith” is related to “John Wilson” through the real world social network named “Porsche Owners Community”, and that “Joe Smith” is currently available for real world social networking (e.g. instant messaging). Other information may also be provided through the alert generated to “John Wilson”, such as the real world location of “Joe Smith”, and/or other information.

Thus in the above described use case example of FIG. 4, the virtual world user “John Wilson” is provided with an alert informing him that the avatar for “Joe Smith” is currently in a virtual conference that his avatar is also attending, without “John Wilson” himself having to explicitly trigger searching of any real world social network databases.

While the above description regarding illustrative embodiments of the disclosed system includes examples of specific user interface operations and/or display objects, the disclosed system is not limited to these specific embodiments. Accordingly, the user interface objects provided herein may be modified as appropriate for various alternative embodiments, using various specific configurations of graphical buttons, menus, dialog boxes, and the like. Those skilled in the art will accordingly recognize that alternative embodiments may use any specific type or kind of user interface display object that may be appropriate to provide the specific operations described.

The disclosed system can take the form of an entirely software embodiment, an entirely hardware embodiment, or an embodiment containing both software and hardware elements. The figures include block diagram and flowchart illustrations of methods, apparatus(s) and computer program products according to an embodiment of the invention. It will be understood that each block in such figures, and combinations of these blocks, can be implemented by computer program instructions. These computer program instructions may be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); and/or (b) information alterably stored on writable storage media (e.g. floppy disks and hard drives).

While the invention is described through the above exemplary embodiments, it will be understood by those of ordinary skill in the art that modification to and variation of the illustrated embodiments may be made without departing from the inventive concepts herein disclosed.

We claim:

1. A method of enhancing a virtual world application, comprising:
detecting a trigger condition in said virtual world application;
searching, in response to said detecting said trigger condition in said virtual world application, at least one real world social networking application relationship database for real world social network relationships between a first user of said virtual world application and at least one other user of said virtual world application; and
displaying, to said first user, at least one real world social network relationship between said first user and a second user of said virtual world application detected by said searching.

2. The method of claim 1, further comprising:
wherein said trigger condition is an implicit trigger condition and said detecting includes automatically detecting that an avatar corresponding to said second user has entered a current context of said virtual world application.

3. The method of claim 2, wherein said current context of said virtual world application includes a current virtual location.

4. The method of claim 3, wherein said current context of said virtual world application includes a current virtual event.

5. The method of claim 4, further comprising:
wherein said detecting includes automatically detecting that said avatar corresponding to said second user is present within said current context of said virtual world application at a current time that falls within a predetermined time period during which said at least one real world social network relationship between said first user and said second user of said virtual world application is permitted to be displayed.

6. The method of claim 1, further comprising:
wherein said trigger condition is an explicit trigger condition and said detecting includes detecting that said first user has requested real world relationship information for an avatar corresponding to said second user.

7. The method of claim 1, wherein said displaying to said first user includes displaying a real world identifier of said second user.

8. The method of claim 7, wherein said displaying to said first user includes displaying a description of said real world social networking application relationship between said first user and said second user

9. The method of claim 8, further comprising:
generating a configuration user interface display to said first user;
inputting, through said configuration user interface display, at least one setting value indicating how real world social networking application information is to be shared with other users of said virtual world application.

10. The method of claim 9, further comprising:
inputting, through said configuration user interface display, at least one setting value indicating how said first user is to be notified of real world social network relationships between said first user and other users of said virtual world application.

11. A system including at least one processor and a computer readable memory for storing program code executable by said at least one processor, said program code including program code for enhancing a virtual world application, said program code for enhancing said virtual world application comprising:
program code for detecting a trigger condition in said virtual world application;
program code for searching, in response to said detecting said trigger condition in said virtual world application, at least one real world social networking application relationship database for real world social network relationships between a first user of said virtual world application and at least one other user of said virtual world application; and
program code for displaying, in a display device of said system, to said first user, at least one real world social network relationship between said first user and a second user of said virtual world application detected by said searching.

12. The system of claim 11, further comprising:
wherein said trigger condition is an implicit trigger condition and said detecting includes automatically detecting that an avatar corresponding to said second user has entered a current context of said virtual world application.

13. The system of claim 12, wherein said current context of said virtual world application includes a current virtual location.

14. The system of claim 13, wherein said current context of said virtual world application includes a current virtual event.

15. The system of claim 14, further comprising:
wherein said detecting includes automatically detecting that said avatar corresponding to said second user is present within said current context of said virtual world application at a current time that falls within a predetermined time period during which said at least one real world social network relationship between said first user and said second user of said virtual world application is permitted to be displayed.

16. The system of claim 11, further comprising:
wherein said trigger condition is an explicit trigger condition and said detecting includes detecting that said first user has requested real world relationship information for an avatar corresponding to said second user.

17. The system of claim 11, wherein said displaying to said first user includes displaying a real world identifier of said second user on said display device.

18. The system of claim 17, wherein said displaying to said first user includes displaying a description of said real world social network relationship between said first user and said second user on said display device.

19. The system of claim 18, said program code further comprising:
program code for generating a configuration user interface display to said first user;
program code for inputting, through said configuration user interface display, at least one setting value indicating how real world social networking application information is to be shared with other users of said virtual world application.

20. The system of claim 19, further comprising:
program code for inputting, through said configuration user interface display, at least one setting value indicating how said first user is to be notified of real world social network relationships between said first user and other users of said virtual world application.

21. A computer program product including a computer readable memory for storing program code executable by at least one processor, said program code including program code for enhancing a virtual world application, said program code for enhancing said virtual world application comprising:
program code for detecting a trigger condition in said virtual world application;
program code for searching, in response to said detecting said trigger condition in said virtual world application, at least one real world social networking application relationship database for real world social network relationships between a first user of said virtual world application and at least one other user of said virtual world application; and
program code for displaying, in a display device of said system, to said first user, at least one real world social network relationship between said first user and a second user of said virtual world application detected by said searching.

22. A system for enhancing a virtual world application, comprising:
means for detecting a trigger condition in said virtual world application;
means for searching, in response to said detecting said trigger condition in said virtual world application, at least one real world social networking application relationship database for real world social network relationships between a first user of said virtual world application and at least one other user of said virtual world application; and
means for displaying, in a display device of said system, to said first user, at least one real world social network relationship between said first user and a second user of said virtual world application detected by said searching.
